(19) United States
(12) Patent Application Publication
(10) Pub. No.: US 2026/0104182 A1
(43) Pub. Date: Apr. 16, 2026

(54) A METHOD OF INSTALLING A HEAT TRANSFER PANEL

(71) Applicant: WATER-FILLED GLASS LTD, Walsall (GB)

(72) Inventor: Matyas GUTAI, Walsall (GB)

(73) Assignee: WATER-FILLED GLASS LTD, Walsall (GB)

(21) Appl. No.: 19/116,797

(22) PCT Filed: Sep. 29, 2023
(86) PCT No.: PCT/GB2023/052532

§ 371 Date: Mar. 28, 2025

(30) Foreign Application Priority Data
Sep. 30, 2022 (GB) 2214432.3

(51) Int. Cl. F24S 20/66; F24S 10/50; F24S 60/30

(52) U.S. Cl. CPC F24S 20/66; F24S 10/50; F24S 60/30

(57) ABSTRACT

A method of installing a heat transfer panel to a building may include (a) providing a heat transfer panel including a frame, and opposing first panel member and second panel members defining a chamber for receiving a fluid heat transfer medium, (b) placing the heat transfer panel to the internal side of the transparent element so that least a portion of the heat transfer panel coincides with at least a portion of the transparent element to permit light passing through the transparent element to transfer energy to the heat fluid transfer medium during use, and (c) after placing the heat transfer panel in step (b), fixing the heat transfer panel relative to the façade.

### FIELD

The present invention relates to heat transfer panels for use in buildings, the installation of heat transfer panels and buildings including heat transfer panels.

### BACKGROUND

The use of heat transfer panels on a building to lower the energy required from energy infrastructure used to supply energy to the building, such as electricity grids and gas lines, to heat the interior space of a building and/or efficiently maintain a thermal balance in the interior space of a building are known or to cool the said interior space are known. For example, WO2012/127451, discloses creating a heat energy system including interconnected heat transfer panels that may contain a fluid heat transfer fluid, such as water for such a purpose. WO'451 discloses connecting the heat transfer panels to form a closed circuit around the surrounding surfaces of part of the interior space of the building.

There is a need to provide for further solutions that may increase energy efficiencies and/or provide for improved installation.

### BRIEF DESCRIPTION OF THE INVENTION

According to an aspect of the present invention, we provide a method of installing a heat transfer panel to a building, the building including:
a load bearing structure for bearing the load of the building and transferring the load to a foundation of the building; and
a façade including a transparent element for permitting light to pass therethrough, wherein the transparent element has an internal side and an external side, and the method including:
   a) providing a heat transfer panel including a frame, and opposing first panel member and second panel members defining a chamber for receiving a fluid heat transfer medium;
   b) placing the heat transfer panel to the internal side of the transparent element so that least a portion of the heat transfer panel coincides with at least a portion of the transparent element to permit light passing through the transparent element to transfer energy to the heat fluid transfer medium during use; and
   c) after placing the heat transfer panel in step b), fixing the heat transfer panel relative to the façade.

Optionally or preferably wherein the internal side has an inwardly facing surface which directly defines a user accessible space of the building during normal use, and/or
wherein the transparent element is an innermost positioned section of the façade in the building relative to the rest of the façade.

According to an aspect of the present invention we provide a method of installing a heat transfer panel to a building, the building including:
a load bearing structure for bearing the load of the building and transferring the load to a foundation of the building; and
a façade including a transparent element for permitting light to pass therethrough, wherein the transparent element has an internal side and an external side, and the method including:
   d) providing a heat transfer panel including a frame, and opposing first panel member and second panel members defining a chamber for receiving a fluid heat transfer medium;
   e) placing the heat transfer panel a pre-determined distance to the external side of the transparent element to form an insulation space between the heat transfer panel and the transparent element and so that least a portion of the heat transfer panel coincides with at least a portion of the transparent element to permit light passing through the transparent element to transfer energy to the heat fluid transfer medium during use; and
   f) after placing the heat transfer panel in step b), fixing the heat transfer panel relative to the façade.

Optionally or preferably wherein the heat transfer panel is configured to permit light to pass therethrough so that light can enter the building by passing through the heat transfer panel and the transparent element whilst permitting a user to see out of the building by looking through the heat transfer panel and the transparent element.

Optionally or preferably wherein the heat transfer panel is configured so that the heat transfer medium is directly heated by light passing through the first and/or second panel members.

Optionally or preferably at least a portion of the first and/or second panel members coincide with at least a portion of the transparent element, optionally or preferably all, or a major portion, of the first and/or second panel members coincide with all, or a major portion of the transparent element.

Optionally or preferably the first and/or second panel members permit light to pass therethrough, optionally or preferably the first and/or second panel members are transparent or optically clear, and step b) includes the heat transfer panel being placed relative to the transparent element to permit light passing through the transparent element to pass through the first and/or second panel members to the heat transfer medium during use.

Optionally or preferably wherein step b) includes placing the heat transfer panel a pre-determined distance from the internal side of the transparent element to form an insulation space between the heat transfer panel and the transparent element.

Optionally or preferably wherein the method includes a step of sealing the insulation space.

Optionally or preferably the method includes a step of removing fluid from the insulation space, optionally or preferably a portion or all of the gaseous fluid.

Optionally or preferably the method includes providing a valve and fluidly connecting the valve to the insulation space, wherein the valve is operable between an open state, in which fluid communication with the insulation space is permitted by the valve, and a closed state, in which fluid communication with the insulation space is inhibited by the valve.

Optionally or preferably the valve is a one-way valve that only permits fluid to flow out of the insulation space.

Optionally or preferably the building first and second sections connected to the load bearing structure that define an interior space of a level of the building, and the façade extends at least a portion between the first and second sections, and wherein step c) includes fixing respective part(s) of the heat transfer panel to the first and second sections respectively.

Optionally or preferably the façade includes a support structure for supporting and fixing thereto the transparent element, and wherein step b) includes providing an internal support structure for supporting the heat transfer panel and fixing the heat transfer panel to the internal support structure.

Optionally or preferably the internal support structure is fixed to the support structure.

Optionally or preferably the internal support structure is fixed to the load bearing structure to inhibit the support structure from bearing the load created by the heat transfer panel.

Optionally or preferably the support structure includes:
one or more horizontal members; and
one or more vertical members,
   wherein the respective one or more horizontal and vertical members are connected to support and have fixed thereto respective parts of the transparent element, and wherein the internal support structure includes:
one or more horizontal members; and
one or more vertical members,
   wherein the respective one or more horizontal and vertical members are connected to support and have fixed thereto respective parts of the heat transfer panel.

Optionally or preferably step b) includes:
ones of the one or more vertical members of the internal support structure being placed adjacent to respective ones of the one or more vertical members of the internal support structure, and optionally or preferably, being aligned relative thereto; and/or
ones of the one or more horizontal members of the internal support structure being placed adjacent to respective ones of the one or more horizontal members of the internal support structure, and optionally or preferably, being aligned relative thereto.

Optionally or preferably the method includes positioning the internal support structure relative to the transparent element to support the heat transfer panel so that the heat transfer panel is at the pre-determined distance to form the insulation space.

Optionally or preferably the internal support structure seals the insulation space.

Optionally or preferably the heat transfer panel includes an inlet in communication with the chamber, and the method includes providing a conduit for the passage of a fluid heat transfer medium, and fluidly connecting the conduit to the inlet to permit a fluid heat transfer medium to flow between the chamber and the conduit during use.

Optionally or preferably the internal support structure defines an internal space for receiving the conduit, and the method includes placing the conduit in the internal space prior to fluidly connecting the conduit to the inlet.

Optionally or preferably a one of the one or more horizontal members define the internal space, and the method includes placing the conduit into the one of the one or more horizontal members.

Optionally or preferably the façade includes multiple transparent elements each having a respective internal and external side, and:
step a) includes providing multiple said heat transfer panels that correspond to the multiple transparent elements;
step b) includes placing each heat transfer panel to the internal side of the corresponding transparent element so that least a portion of the heat transfer panel coincides with a portion of the transparent element to permit light passing through the transparent element to transfer energy to the heat fluid transfer medium during use; and
step c) includes after placing each heat transfer panel in step b), fixing each heat transfer panel relative to the external wall or façade.

Optionally or preferably the method includes fluidly connecting a portion, or all, of the said heat transfer panels together to permit fluid heat transfer medium to flow between the heat transfer panels during use.

Optionally or preferably the building includes multiple said façades, and the method is performed to install heat transfer panels to more than one of the said façades.

Optionally or preferably the method includes providing a fluid control system for selectively permitting fluid heat transfer medium to flow between the said heat transfer panels, and/or selectively forming one or more fluid heat transfer medium circuits between the said heat transfer panels to prevent the flow of fluid heat transfer medium between the one or more fluid heat transfer medium circuits.

Optionally or preferably the multiple said façades include:
a first façade which faces in a first direction; and
a second façade which faces in a second direction that is different to the first direction; optionally or preferably an opposite direction to the first direction; and
the method includes:
selecting the first and second façades, installing the heat transfer panels to the first and second façades to form first and second fluid heat transfer medium circuits, and
fluidly connecting the first and second fluid heat transfer medium circuits.

Optionally or preferably the building includes a heat management system and the method includes thermally connecting the heat transfer panel(s) to the heat management system to permit the transfer of heat between the fluid heat transfer medium and the heat management system.

Optionally or preferably the heat management system includes one or more of a heat exchanger, heat storage device and heat pump, and the method includes thermally connecting the heat transfer panel to one or more of the heat exchanger, heat storage device, heat pump, a heating device, cooling device or energy source.

Optionally or preferably the façade(s) are pre-existing façade(s) of the building.

According to an aspect of the present invention we provide a building including:
a façade including a transparent element for permitting light to pass therethrough, wherein the transparent element has an internal side and an external side, and
a heat transfer panel including a frame, and opposing first panel member and second panel members defining a chamber for receiving a fluid heat transfer medium,
wherein the heat transfer panel is positioned a pre-determined distance to the external side of the transparent element to form an insulation space so that least a portion of the heat transfer panel coincides with at least a portion of the transparent element to permit light passing through the transparent element to transfer energy to the heat fluid transfer medium during use.

Optionally or preferably the façade includes multiple transparent elements each having a respective internal and external side, and multiple said heat transfer panels that correspond to the multiple transparent elements, wherein each heat transfer panel is positioned a pre-determined distance to the external side of the corresponding transparent element to form an insulation space and so that least a portion of the heat transfer panel coincides with a portion of the transparent element to permit light passing through the transparent element to transfer energy to the heat fluid transfer medium during use.

Optionally or preferably a portion, or all, of the said heat transfer panels are fluidly connected together to permit fluid heat transfer medium to flow between the heat transfer panels during use.

Optionally or preferably the building includes multiple said façades, and includes multiple said heat transfer panels, wherein each heat transfer panel is positioned to the internal side of the corresponding transparent element so that least a portion of the heat transfer panel coincides with at least a portion of the transparent element to permit light passing through the transparent element to transfer energy to the heat fluid transfer medium during use.

Optionally or preferably the building includes a fluid control system for selectively permitting fluid heat transfer medium to flow between the said heat transfer panels, and/or selectively forming one or more fluid heat transfer medium circuits between the said heat transfer panels to prevent the flow of fluid heat transfer medium between the one or more fluid heat transfer medium circuits.

According to an aspect of the present invention, we provide a heat transfer panel for use in a building including:
a frame including at least one frame member including:
   a chamber for receiving a fluid heat transfer medium;
   a first side including a first opening in communication with the chamber and a face;
   a second side, opposite the first side, including a second opening in communication with the chamber and a face;
   an inlet in communication with the chamber;
   an outlet in communication with the chamber;
a first panel member attached to the face of the first side to cover the first opening and a second panel member attached to the face of the second side to cover the second opening,
   wherein the heat transfer panel includes a peripheral cavity which extends around a circumference of the heat transfer panel;
   a conduit member connected to the frame and in fluid communication with the chamber, wherein the conduit member includes:
   a first end portion proximate the at least one frame member and defines a first aperture;
   a second end portion distal from the at least one frame member and defines a second aperture; and
   a coupling device for releasably coupling the conduit member to an extension conduit member,
wherein the second end portion terminates within the peripheral cavity.

Optionally or preferably the coupling device is for releasably coupling a cover member for covering the second aperture, optionally or preferably the cover member is coupled to the coupling device.

Optionally or preferably the coupling device includes a first co-operating formation formed on the second end portion for co-operating with a respective co-operating formation of the extension conduit member and/or a respective co-operating formation of the cover member.

Optionally or preferably the first end portion of the conduit member is connected to a part of the frame that defines the inlet.

Optionally or preferably the one or both of the first and second panel members extend past the frame, optionally or preferably extend past the frame to define the peripheral cavity.

Optionally or preferably the heat transfer panel includes a further conduit member connected to the at least one frame member and in fluid communication with the chamber, wherein the further conduit member includes:
a first end portion proximate the frame and defines a first aperture;
a second end portion distal from the frame and defines a second aperture; and
a coupling device for releasably coupling the conduit member to one of: an extension conduit member, and/or a cover member for covering the second aperture,
wherein the second end portion terminates within the peripheral cavity.

Optionally or preferably the inlet is an aperture in the frame and/or the outlet is an aperture in the at least one frame member.

Optionally or preferably the first aperture of the conduit is aligned to the inlet and/or the first aperture of the further conduit is aligned to the outlet.

Optionally or preferably the peripheral cavity extends around the entire circumference of the frame. Optionally or preferably the peripheral cavity contains a sealant material.

### BRIEF DESCRIPTION OF THE FIGURES

In order that the present disclosure may be more readily understood, preferable embodiments thereof will now be described, by way of example only, with reference to the accompanying drawings, in which:

FIG. 1 is a schematic diagram of a portion of a building according to an example embodying the present disclosure;

FIG. 2 is a schematic diagram illustrating a plurality of heat transfer panels connected to a heat management system of the building of FIG. 1 according to an example embodying the present disclosure;

FIG. 3 is an exploded perspective view of a heat transfer panel for use with a method according to an example embodying the present disclosure;

FIG. 4 is a partial perspective view of a portion of the building of FIG. 1 to which heat transfer panels may be installed according to an example embodying the present disclosure;

FIG. 5 corresponds to the portion of the building shown in FIG. 4 with the heat transfer panels installed according to an example embodying the present disclosure;

FIG. 6 is a cross-section view showing a part of the portion of the building shown in FIG. 5;

FIGS. 7 to 9 correspond to the view shown in FIG. 5 at various stages of a heat transfer panel being installed according to an example embodying the present disclosure;

FIG. 10 is a partial cross-section perspective view of a portion of a building to which heat transfer panels have been installed according to an example embodying the present disclosure;

FIGS. 11a to 11c correspond to various partial cross-section views of the portion of the building shown in FIG. 10;

FIG. 12 is an elevation view of a heat transfer panel according to an example embodying the present disclosure;

FIG. 13 is a cross-section view of the heat transfer panel through the line X-X of FIG. 12;

FIG. 14 is an exploded view of the heat transfer panel shown in FIG. 12.

FIG. 15 is a cross-section view showing a portion of the heat transfer panel of FIG. 12;

FIG. 16 is a cross-section view showing another portion of the heat transfer panel of FIG. 12;

FIG. 17 is a cross-section view corresponding to the view of FIG. 15 with a certain component part connected to the heat transfer panel; and

FIG. 18 is a cross-section view corresponding to the view of FIG. 15 with a certain component part connected to the heat transfer panel.

### DETAILED DESCRIPTION OF THE DISCLOSURE

An example of a method of installing a heat transfer panel to a building according to the present disclosure will be described with reference to the figures.

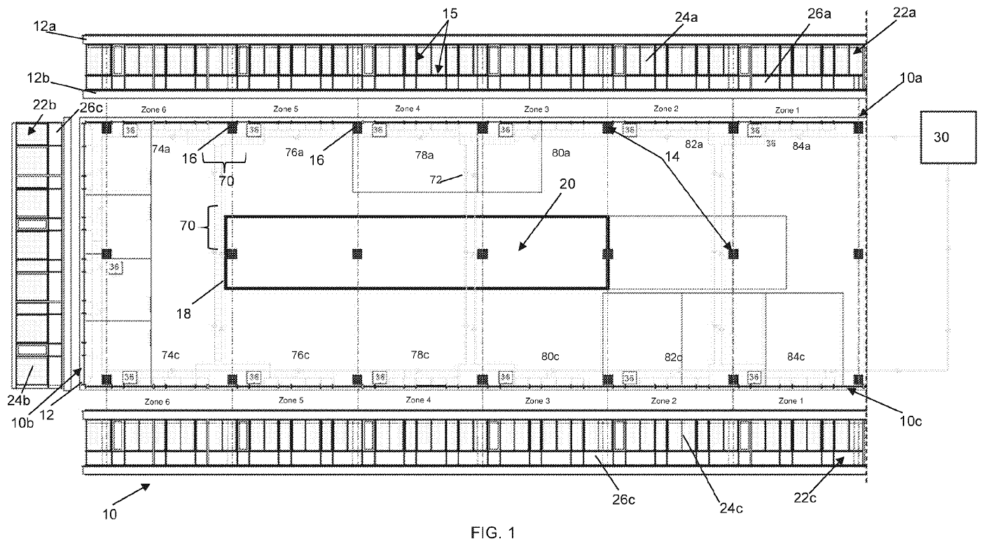

FIG. 1 is a schematic diagram showing a portion of a building 10 to which heat transfer panels 100 have been installed. The building 10 is a multilevel building. A level 12 of the building 10 is shown in plan cross-section generally centrally in FIG. 1. The building 10 includes a load bearing structure 14 including an array of equidistantly spaced columns 16 which extend from the ground to the top of the building 10. The columns 16 may be made from concrete or other suitable materials as is known in the art. The building 10 includes an inner core 18 which is positioned generally centrally of the building 10 and extends from the ground to the top of the building 10. The inner core 18 defines a central space 20 that extends between the levels of the building 10. The core 18 may include, for example, staircases and/or elevators to permit movement of people between the levels, and/or service architecture such as electrical cables, water or riser components that extend vertically through the building such as air conditioning ducts, conduits and other cables. The load bearing structure 14 is for bearing the load of the building 10 and transferring the load to a foundation of the building 10. The level 12 is formed by upper and lower sections 12a, 12b that are connected to the load bearing structure 14, e.g. to the columns 16. For example, each of the sections 12a, 12b may include planar concrete slabs that are connected to the columns 16 directly to form respective ceiling and floor of the level 12.

The building 10 has sides 10a, 10b, 10c that form a rectangular shape. These are shown in front view adjacent to the respective sides of the building 10 in FIG. 1.

Each side 10a, 10b, 10c includes a façade 22a, 22b, 22c. The term façade denotes the external wall or outer components of the building 10 that form the outer surface of the building. In this example, each façade 22a, 22b, 22c includes a plurality of transparent elements 24a, 24b, 24c, and a plurality of panels 26a, 26b, 26c. Each façade is constructed in the same way and so only one façade 22a will be described in detail, with the corresponding integers of the other façades sharing the same reference numeral with a corresponding suffix of ‘b’, ‘c’ for the respective façade 22b, 22c. In examples, one or more of the façades 22a, 22b, 22c may be a single section, e.g. form a single wall, or have two sections, e.g. have an exterior section or wall and an interior section or wall spaced inwardly apart from the exterior section or wall. In the case of a façade having a single exterior section or wall, this may include a transparent or translucent element. In examples, the corresponding heat transfer panel 100 may be installed to the internal side of the transparent or translucent element of the exterior section or wall. In the case of a façade having two sections, the exterior section may include transparent or translucent elements, e.g. glazing or the like, and the interior section or wall may include a transparent or translucent element. In examples, the corresponding heat transfer panel 100 may be installed to the internal side of the transparent or translucent element of the interior section or wall.

Façade 22a is connected to the loading bearing structure 14 by a support structure 15 attached to the loading bearing structure 14, e.g. to the columns 16, that define a plurality of openings in communication with the internal space of the building 10 and the level 12. The transparent elements 24a are planar members. The transparent elements 24a are connected to cover respective portions of the openings formed by the support structure 15 to form horizontal sections of adjacent transparent elements 24a that are separated by respective ones of the panels 26a between each horizontal section. The transparent elements 24a may be made from a transparent or optically clear material, e.g. glass. Each transparent element 24a has an internal side that faces inwardly to the interior space of the building 10, and an external side that faces outwardly away from the interior space of the building 10. In examples, the internal side has an inwardly facing surface which directly defines a user accessible or functionally accessible space of the building during normal use. In examples, the terms “user accessible space” and “functionally accessible” space, denote a space within the building that can be used or forms a practically useful space during normal use of the building In examples, one or more of the transparent elements 24a may be an innermost positioned section of the façade 22a in the building relative to the rest of the façade 22a. The panels 26a are made from an opaque material. Other than the panels 26a positioned between the horizontal sections of adjacent transparent elements 24a, the rest of the panels 26a are connected to the support structure 15 to cover the openings therein and form respective continuous lines of panels 26a along the top and bottom of the transparent elements 24a. In examples, the transparent elements 24a, and panels 26a may be arranged differently. For example, there may be no panels 26a, and the façade may entirely consist of transparent elements 24a. In examples, one or more of the transparent elements 24a may be arranged to lie adjacent one another in a vertical direction and optionally also in a horizontal direction.

In examples, the façade 22a may have a different configuration. For example, the support structure 15 may form part of the external surface of the façade 22a and is not covered completely by the transparent elements 24a and panels 26a. In examples, the façade 22a may be a solid wall with openings therein that are covered by transparent elements 24a.

The façade 24a includes a plurality of heat transfer panels 100 (not visible in FIG. 1) adjacent, and coincident with, the internal sides of the transparent elements 24a. In examples, one or more of the heat transfer panels 100 may entirely cover the corresponding transparent elements 24a or smaller portions of the corresponding transparent elements 24a. Different ones of the heat transfer panels 100 may cover different amounts of the corresponding ones of the transparent elements 24a. This will depend on the cost and/or the material benefit associated with the how much of the transparent elements 24a are covered. Each heat transfer panel 100 includes a fluid heat transfer medium. The fluid heat transfer medium may be water, or another liquid that is suitable for heat transfer, or it may be a gas, e.g. air. In examples, the heat transfer panels 100 are configured to permit light to pass therethrough so that light can enter the building by passing through the heat transfer panels 100 and the transparent elements 24a whilst permitting a user to see out of the building by looking through the heat transfer panels 100 and the transparent elements 24a. Thus, a user may continue to look through the transparent elements 24a and out of the building after the heat transfer panels 100 have been installed.

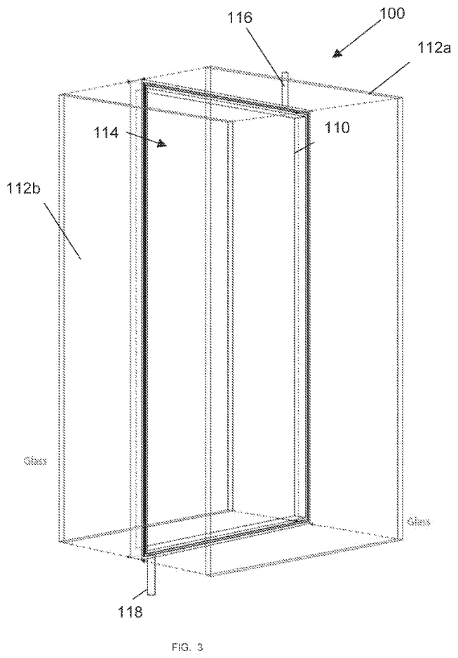

An example of a heat transfer panel 100 is shown in FIG. 3. The heat transfer panel 100 includes a frame 110, and opposing first and second panel members 112a, 112b attached to the frame 110 to define a chamber 114 for receiving the fluid heat transfer medium. The use of the term “frame” in this disclosure is to denote the internal structure which creates a space between the first and second panel members 112a, 112b. It may be referred to as a “spacer” in the art as well. The heat transfer panel 100 includes an inlet conduit member 116 in communication with the chamber 114, and an outlet conduit member 118 in communication with the chamber 114. In this example, the inlet conduit member 116 is provided at an upper end of the frame 110 and the outlet conduit member 118 is provided at a lower end of the frame 110. However, in examples this arrangement may be reversed, e.g. the inlet conduit member 116 may be provided at the lower end of the frame 110 and the outlet conduit member 118 provided at the upper end of the frame depending on the climate, e.g. a climate where cooling is primarily required. The conduit members 116, 118 are tubular members. The panel members 112a, 112b may be made from a transparent or optically clear material, e.g. glass or other suitable materials. The frame 110 is generally U-shaped in cross-section to define a space which extends around the circumference of the frame 110 and is filled with a sealant (not shown). It will be understood that the frame 110 may have other shaped cross-sections in examples without departing from the present disclosure. The sealant may be silicone or another suitable material, for example.

Each heat transfer panel 100 is positioned to the internal side of the corresponding transparent element 24a so that the heat transfer panel 100 coincides with the transparent element 24a to permit light passing through the transparent element 24a to transfer energy to the heat fluid transfer medium during use. The first and/or second panel members 112a, 112b may coincide with the transparent element 24a so that light strikes the members 112a, 112b and/or passes into the chamber 114 to be absorbed by the fluid heat transfer medium. In examples, the first and/or second panel members 112a, 112b may absorb energy from the light and, due to the thermal contact between the members 112a, 112b and the fluid heat transfer medium, energy may be transferred between the members 112a, 112b and the fluid heat transfer medium during use. For example, where one or both of the members 112a, 112b are opaque or translucent, the energy may be primarily transferred through thermal conduction to the fluid heat transfer medium during use. The heat transfer panels 100 are configured so that the heat transfer medium is directly heated by light passing through the first and/or second panel members 112a, 112b. The panels may be arranged to minimise or reduce any absorption of the light by the first and/or second panel members 112a, 112b, e.g. by being transparent or translucent. The heat transfer panels 100 are thus different to so-called solar collectors which are generally configured to include a body coated or formed from an opaque material, e.g. a black body or coating, and arranged to receive light thereon so that the body absorbs the incident light and is heated. A heat transfer liquid, e.g. water, is passed through the body so that heat from the body is transferred to the body by conduction. The heat transfer panels 100 are configured to permit the light to directly heat the heat transfer medium. This differs from solar collectors for which the heat transfer liquid is heated indirectly by the light.

The method of the present disclosure may be used with any arrangement of transparent elements 24a and/or façade 22a as will be described.

In the example installation shown in FIG. 1, the building 10 is shown installed with a fluid control system 70 for selectively permitting fluid heat transfer medium to flow between the heat transfer panels 100. The fluid control system 70 may include a network of conduits, e.g. tubular pipes, which are fluidly connected to the heat transfer panels 100 so that fluid heat transfer medium can flow between them. The fluid control system 70 may include flow control devices 72, e.g. valves, to permit control of which of the heat transfer panels 100 are in fluid communication. In examples, the flow control devices 72 may be controlled to open and close to form a plurality of different circuits as required.

For example, referring to FIG. 1, the fluid control system 70 may be configured for selectively forming one or more fluid heat transfer medium circuits between the said heat transfer panels 100 to prevent the flow of fluid heat transfer medium between the one or more fluid heat transfer medium circuits. For example, referring to façade 22a, six sets of heat transfer panels 100 are fluidly connected to form separate respective circuits 74a, 76a, 78a, 80a, 82a, 84a, and referring to façade 22c, six sets of heat transfer panels 100 have been connect to form respective circuits 74c, 76c, 78c, 80c, 82c, 84c. The direction of flow of the heat transfer fluid medium between the circuits is indicated in FIG. 1.

The fluid control system 70 includes conduits (not shown) that fluidly connect the heat transfer panels 100. The conduits may be pipes that are installed within spaces such as the space within raised flooring, suspended ceiling and/or spaces formed by cavities within panel walls of the building 10.

The fluid control system 70 fluidly connects ones of the respective circuits 74a, 76a, 78a, 80a, 82a, 84a of the first façade 22a to corresponding ones of the circuits 74c, 76c, 78c, 80c, 82c, 84c of the façade 22c. The connections are formed to permit heat transfer fluid medium to flow between heat transfer panels 100 situated on different façades of the building 10. This may be advantageous where, for example, façade 22a is orientated such that, it receives more sunlight over the course of a day compared to façade 22c. In this situation, the heat transfer fluid medium will absorb the solar energy across the heat transfer panels 100 of façade 22a causing it to be heated whilst the heat transfer fluid medium across the heat transfer panels 100 of façade 22c would be comparatively cooler. By having the respective circuits of the façade 22a and 22c fluidly connected, the heated heat transfer fluid medium will flow from the heat transfer panels 100 of façade 22a to the heat transfer panels 100 of façade 22c and displacing the cooler heat transfer fluid medium to flow in the opposite direction. In this way, a thermal balancing occurs between the heat transfer panels 100 of façades 22a and 22c. Due to the heat transfer panels 100 being placed internally within the space of the building 10, they are in thermal contact with the internal environment. Therefore, any heat absorbed by the heat transfer panels 100 at façade 22a is advantageously transferred away due to the flow of the heat transfer fluid medium which prevents heating of the internal environment whilst the opposite is true at façade 22c, where the heat is transferred into the internal environment at this side of the building 10 causes it to be advantageously heated. The heat transfer panels 100, due to their placement, effectively function as heat sources or heat sinks for the internal environment or space of the building 10 meaning that less energy is required from externally supplied energy sources, e.g. gas and/or electricity from the energy infrastructure to create the same thermal balancing effect. It will be appreciated that the heat transfer panels 100 may be connected into different types of circuits. The heat transfer panels 100 may also save further energy by absorbing heat that would normally enter the building through the transparent elements and therefore lowers the cooling demand. Furthermore, the heat can be stored/used in the building, e.g. in a water tank of the building, or to heat the interior space of the building later. The heat fluid transfer medium may be connected to a standard heating system, which may also save energy as well, e.g. by using heat pumps. Furthermore, the heat transfer panels may also be connected to relatively less expensive heating and/or cooling sources, for example, utilising the heat exhausted by computer servers located in the building, the heating/cooling effect of long water tanks located in the building (e.g. fire water tanks), or geothermal energy from the ground, which saves energy overall compared to other systems.

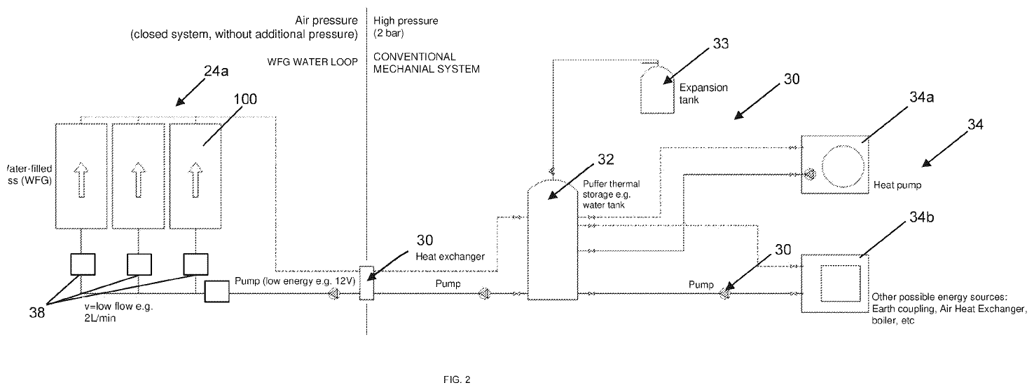

With reference to FIG. 2, this is a schematic diagram illustrating the façade 22a including a plurality of heat transfer panels 100 connected as a circuit, e.g. circuit 74a, to a heat management system 30 of the building 10. The heat management system 30 is fluidly connected to the heat transfer panels 100 by the fluid control system 70. The heat management system 30 controls the temperature and thermal conditions within the building 10. The heat management system 30 may be configured to manage independent temperature and thermal conditions for separate parts of a given level of the building 10, and/or a section or enclosed space within the same level of the building 10. The heat management system 30 may include a thermal storage device 32, e.g. a water tank, for receiving/circulating the fluid heat transfer medium. The thermal storage device 32 may be connected to an expansion tank 33 for controlling the pressure of the fluid heat transfer medium if it undergoes any thermal expansion. The thermal storage device 32 may be fluidly connected to one or more heat sources or heat exchangers 34. For example, heat source 34a may be a heat pump for providing thermal energy to the fluid heat transfer medium to increase the amount of thermal energy within the fluid heat transfer medium. The heat sources 34 may include one or more of: an air based heat exchanger 34b to transfer thermal energy from high temperature ambient air to the fluid heat transfer medium, boiler or other type of thermal coupling to the earth, e.g. a geothermal heat pump. In examples, the heat management system 30 may be pre-existing system of a building 10 and the heat transfer panels 100 and associated components may be connected to the system 30 as part of the installation process.

The heat transfer panels 100 may be fluidly connected to form closed circuits by the fluid control system 70 that are each fluidly connected to the heat management system 30 to place the closed circuits into fluid communication with the heat transfer panels 100. For example, there may be one or more heat exchangers 36 that form a link between a circuit of heat transfer panels 100 and the heat management system 30. The heat exchangers 36 may permit thermal energy or heat within the fluid heat transfer medium to be transferred to the fluid heat transfer medium of the heat management system 30 for use downstream in managing the temperature or thermal conditions within the building 10 as required. The heat exchangers 36 may also permit thermal energy or heat within the heat management system 30 to be transferred to the fluid heat transfer medium circulating between the heat transfer panels 100. There may be a plurality of fluid movers 38, e.g. pumps, provided to assist in moving the fluid heat transfer medium between the heat transfer panels 100 and/or the heat management system 30. The flow rate of fluid heat transfer medium within the circuit and associated power consumption of the fluid movers 38 may be low.

For example, referring to FIG. 1, each of the circuits 74a-84a, and circuits 74c-84c may have a heat exchanger 36 connected thereto for transferring heat between the the fluid heat transfer medium and the heat exchanger 30 for use elsewhere by the heat management system 30.

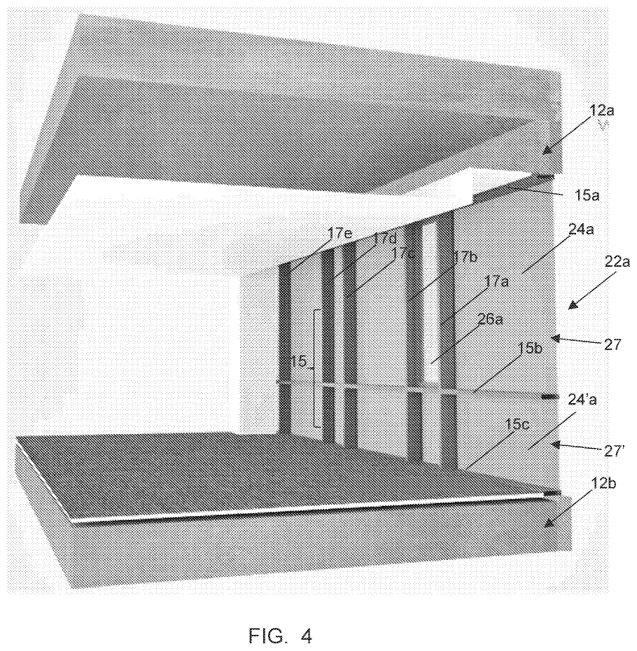

Installation of a heat transfer panel 100 according to the present disclosure will now be described. Referring to FIG. 4, this is a partial perspective cross-section view of a façade 22a of building 10 to which the heat transfer panels 100 will be installed. In this example, the heat transfer panels 100 are being installed to an existing building and façade 22a as a retrofit installation. In examples, the heat transfer panels 100 may be installed as part of a new building construction with the façade 22a being built first and the heat transfer panels 100 installed thereafter. In the examples, the façade 22a is already installed and in place before any installation of the heat transfer panels.

In this example, façade 22a includes two rows of transparent elements 24a, 24a′ with a first row 27 of transparent elements 24a adjacent and directly above a second row 27′ of transparent elements 24a′. A panel 26a is positioned between a pair of transparent elements 24a. The support structure 15 is connected to respective sections 12a, 12b and the columns 16.

In more detail, the support structure 15 includes horizontal members 15a, 15b, 15c. The support structure includes vertical members 17a, 17b, 17c, 17d, 17e that extend between the sections 12a, 12b and are connected at their respective ends to the upper and lower sections 12a, 12b. The vertical members 17a-17e may be referred to as mullion members. The members 15a-15c may be referred to as transom members and are formed of elements that extend between and are connected at their respective ends to adjacent vertical members 17a-17e. The horizonal members 15a, 15b, 15c are spaced apart in the vertical direction with members 15a, 15b being a greater distance apart compared to the distance between the members 15b, 15c. Vertical members 17a, 17b and 17c, 17d are respective pairs that are closer together to form smaller openings between each pair in comparison to the respective pairs of vertical members 17b, 17c, and 17d, 17e which are further apart to form larger openings between each pair. Transparent elements 24a, 24a′ and panel 26a are connected to the outer parts of the members 15a-c, and 17a-17d so as to form the outer surface of the façade 22a and to cover the openings therebetween.

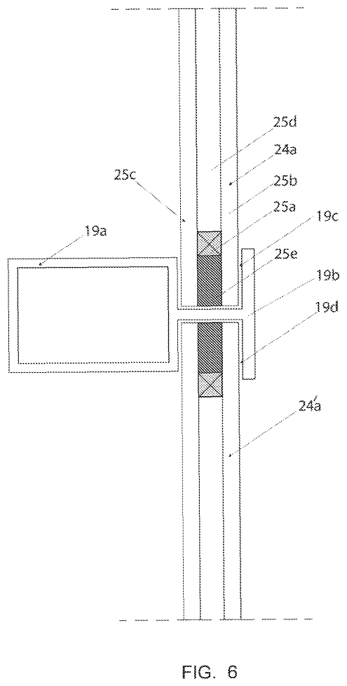

FIG. 6 is a side cross-section view showing a portion of the arrangement of transparent elements 24a, 24′a of FIG. 4 that are adjacent to one another in the vertical direction. Other than their relative size, the transparent elements 24a, 24′a are identical and so only one of the elements 24a will be described with transparent element 24′a sharing the same integers denoted with a 'suffix.

Transparent element 24a includes a frame 25a to which are attached panels 25b, 25c to define a cavity 25d therebetween. The panels 25b, 25c are transparent, e.g. made from glass. The cavity 25d is sealed with respect to the frame 25a. The cavity 25d may include an insulative fluid such as an inert gas or air. The panels 25b, 25c extend past the respective edges of the frame 25a to define a peripheral cavity that is filled with a sealant 25e such as silicone or another suitable material.

Horizontal member 15b is positioned between the lower end of transparent element 24a and the upper end of transparent element 24′a. In side view, the horizontal member 15b has a profile formed of a first section 19a and a second section 19b. The first section 19a is a hollow box section and the second section 19b is T-shaped to define a pair of oppositely orientated U-shaped formations 19c, 19d. Formation 19c faces open upwardly and formation 19d faces open downwardly. The respective ends of the transparent elements 24a, 24′a are received in formations 19c, 19d respectively. Horizontal members 15a, 15c are similarly formed to horizontal member 15b to receive the respective other ends of the transparent elements 24a, 24′a.

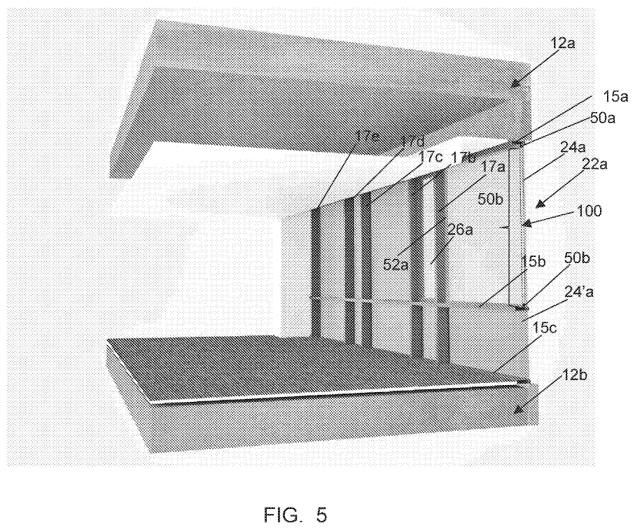

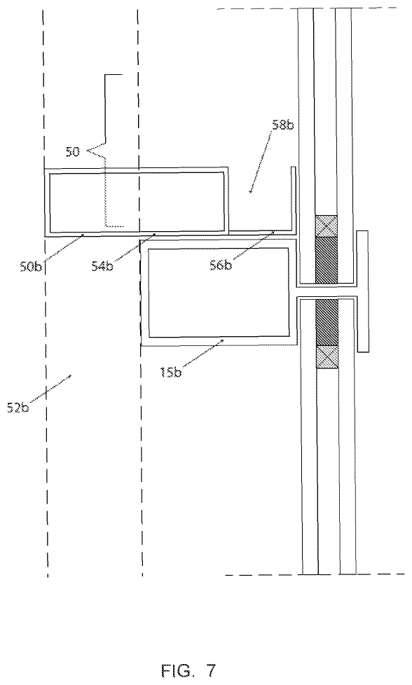

Referring to FIG. 5, and FIGS. 7 to 9, the method includes providing an internal support structure 50 for supporting the heat transfer panels 100 and fixing the heat transfer panels 100 to the internal support structure 50. The internal support structure 50 may be located internally within the interior space of the building 10. In examples, the internal support structure 50 is fixed to the support structure 15 where the support structure has sufficient load bearing capacity to bear the load of the transparent elements 24a, 24′a and the heat transfer panels.

In the present example, the internal support structure 50 is fixed to the load bearing structure 14 to inhibit the support structure 15 from bearing the load created by the heat transfer panels 100. In other examples, one or more parts of the internal support structure 50 may be fixed to the support structure 15, and/or fixed to a further load bearing structure which may be installed, e.g. between members 12a, 12b and the internal support structure 50. In such examples, the load created by the heat transfer panels 100 may be wholly or partly borne by the support structure 15 and/or the further loading bearing structure that is installed.

Referring to FIG. 5 this shows the arrangement of FIG. 4 with a partial installation of the internal support structure 50 connected with a single heat transfer panel 100 fixed adjacent the transparent element 24a.

As will be described, the internal support structure 50 includes horizontal members 50a-c (only members 50a, 50b are shown in FIG. 5) and vertical members 52a-e (only member 52a is shown in FIG. 5) which correspond to the horizontal members 15a-c and vertical members 17a-e respectively. In this example, the horizontal members and vertical members of the internal support structure 50 are placed adjacent and are aligned relative to the corresponding ones of the members 15a-c, and 17a-e to permit installation of heat transfer panels 100 adjacent respective ones of the transparent elements 24a, 24′a. For the purpose of the present description, only those members will be described for installation of the heat transfer panel 100 adjacent the transparent element 24a but it will be appreciated how the other members would be installed for installation of the remainder of the heat transfer panels 100.

The internal support structure 50 is first created, before the heat transfer panels 100 are connected thereto. Referring to FIG. 7, this is a side cross-section view corresponding to FIG. 6 but with a vertical member 52b of the internal support structure 50 in dashed lines that has been fixed in place with its respective ends coupled to the load bearing structure 14, e.g. to the upper and lower sections 12a, 12b. A horizontal member 50b is shown in side cross-section view. The horizontal member 50b is connected at its ends to the vertical member 52b, and the adjacent vertical member 52c respectively. The horizontal member 50b includes a first section 54b and a second section 56b. The first section 54b is box shaped in cross-section and the second section 56b is L-shaped so as to define an upwardly facing U-shaped recess 58b between the first and second sections 56b. It should be understood that the sections 54b, 56b may be configured differently to provide the recess 58b and/or may be orientated differently depending on the required configuration. For example, where the members 50a, 50b have different shapes, e.g. L-shape cross-sections, then the recess 58b may be a downwardly facing recess. The horizontal member 50b rests on the horizontal member 15b with the first section 54b extending over and past the inwardly facing side of the horizontal member 15b, and the second section 56b being adjacent the transparent element 24a. In examples, the horizontal member 50b may not rest on the horizontal member 15b and instead be spaced apart therefrom. The horizontal member 50a is similarly configured to horizontal member 50b except its first and second sections 54a, 56a are arranged so that the recess 58a is downwardly facing.

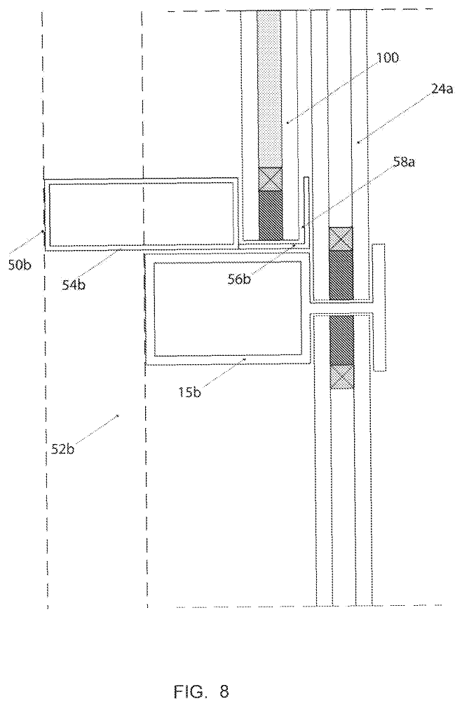

Referring to FIG. 8, once the internal support structure 50 has been created, the heat transfer panel 100 may be received by the horizontal members 50a, 50b with the respective upper and lower ends of the heat transfer panel 100 being received in the respective recesses 58a and 58b thereof. The heat transfer panel 100 is now adjacent to the transparent element 24a with a negligible space therebetween. The other heat transfer panels 100 may be similarly received by respective elements of the horizontal members 50a, 50b and the vertical members 52a-e. A sealant is applied to seal the heat transfer panel 100 relative to the internal support structure 50.

The heat transfer panels 100 may be fluidly connected to each other and/or the fluid control system 70 as will now be described. Starting from the state shown in FIG. 8, this may include providing conduits and fluidly connecting them to the respective outlet and inlet conduits of the heat transfer panels 100. The conduits 60 may form a network of conduits which fluidly connect the heat transfer panels 100 together so that heat fluid transfer medium may flow between the heat transfer panels 100 during use. In examples, the conduits 60 may be placed within internal spaces defined by the internal support structure 50.

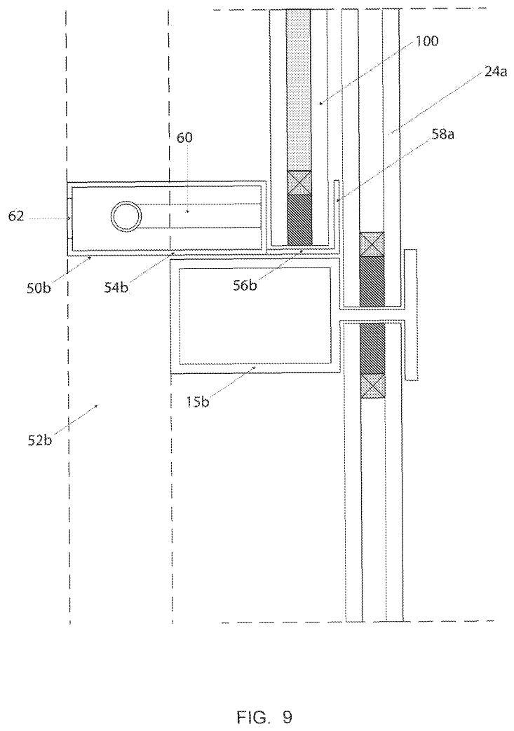

For example, referring to FIG. 9, the horizontal member 50b may include an opening 62 in the first section 54a through which a conduit 60 is inserted to be placed in the internal space of the first section 54a. Conduit 60 may be connected to the outlet conduit 118 of the heat transfer panel 100 by an elbow joint or the like. Similarly, horizontal member 50a may receive a conduit which is similarly connected to the inlet conduit 116.

An advantage of the method described, is that the heat transfer panels 100 may be installed in a building having a pre-existing façade without having to modify and/or remove any elements of the façade.

An advantage of the method described is that it permits heat transfer panels 100 to be installed in a building having a pre-existing façade without the requirement for scaffolding or access to the building external which could otherwise cause great disruption and complicate installation. Having the heat transfer panels 100 installed internally of the façade thus makes their use suitable for a wider range of buildings than may otherwise be the case. For example, the teachings of WO'451 are limited to installing heat transfer panels that are installed as an external façade of a building, or installing the heat transfer panels as an external façade of a new build construction. In comparison to conventional retrofit systems, the present example method saves energy, lowers cost and waste compared to having to install separate scaffolding and removing an existing external façade.

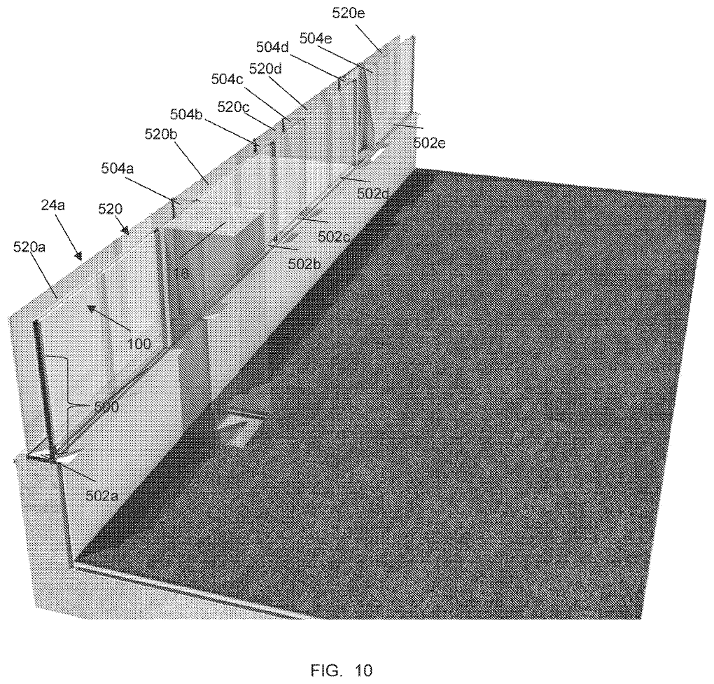

Referring to FIG. 10, this is a perspective partial cross-section view of a façade for which heat transfer panels 100 have been installed according to examples of the present disclosure. The configuration of the transparent elements 24a, and support structure 15 is in accordance with that described previously. The main difference is that the internal support structure 500 is configured so that the heat transfer panels 100 are supported to be at pre-determined distances relative to their corresponding transparent element 24a to form insulation spaces 520 therebetween. In particular, each heat transfer panel 100 is a pre-determined distance from the internal side of the corresponding transparent element 24a to form the insulation space 520 between the heat transfer panel 100 and the transparent element 24a. In examples, the insulation spaces 520 may be sealed, for example, by the internal support structure 500 and sealing applied therebetween. The installation may include a step of removing fluid from the insulation spaces 520. This may be a portion, or all of the gaseous fluid. In examples, the installation may include providing a valve and fluidly connecting the valve to the insulation space 520. The valve may be operable between an open state, in which fluid communication with the insulation space is permitted by the valve, and a closed state, in which fluid communication with the insulation space is inhibited by the valve. The valve may be a one-way valve that only permits fluid to flow out of the insulation space. In examples, the valve may be arranged to permit communication between the insulation space and the interior space of the building. In examples, the valve may be arranged to permit communication between the insulation space and the external space outside the building. In examples, the valve may be arranged to permit communication between the insulation space and one or both of the interior and external space.

In more detail, and referring to FIG. 10, the internal support structure 500 is similar to internal support structure 15 in that it includes a plurality of horizontal members 502a, b, d, e, f, and vertical members 504a, b, c, d, e. The main distinction is that the members are arranged to support the heat transfer panels 100 so that they are separated at pre-determined distance away from the transparent elements 24a to form respective insulation spaces 520a, 520b, 520c, 520d, 520e. The insulation spaces are effective in providing thermal insulation between the transparent elements 24a and the heat transfer panels 100 so that the thermal contact between the transparent elements 24a and the heat transfer panels 100 is effectively reduced. The insulation spaces 520 may be vacuum sealed in examples. For examples where there is no vacuum sealing, where the insulation spaces 520 are more than a pre-determined distance above which convection or eddy currents may form in any fluid present therein, e.g. more than 40 mm, there may be further panels, e.g. panes of transparent material such as glass, placed in the insulation spaces 520 to created smaller divided insulation spaces to prevent such circulation from occurring therein.

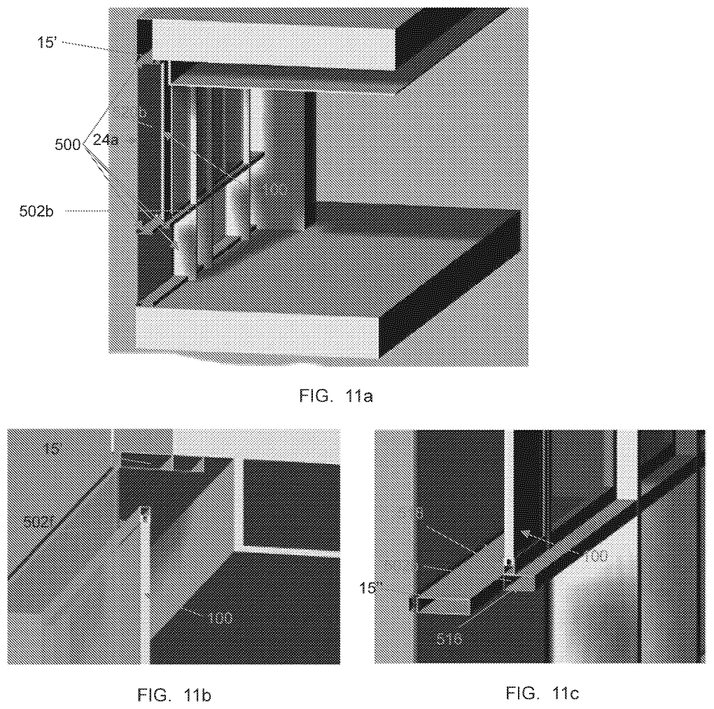

Referring to FIGS. 11a to 11c, these are respective partial cross-section perspective views showing different portions of the internal support structure 500 shown in FIG. 10. Referring to FIG. 11a, horizontal member 502b is shown together with a further horizontal member 15′ which is not visible in FIG. 10that may be a part of the support structure 15 that supports the transparent element 24a. Horizontal members 502b and 502f are vertically spaced apart and face each other to define an opening through which the transparent element 24a extends, with member 502b forming a bottom side of the opening and member 502f forming a top side of the opening. In examples, the members 502b, 502f may be configured differently, e.g. not face each other, depending on the configuration of the existing building. Referring to FIG. 11b, this shows member 502f. Member 502f is a generally elongate shape that is U-shaped in cross-section, e.g. a U-shaped beam. Member 502f is open in the direction towards the member 502b, i.e. downwardly. Member 502f is connected at its respective ends to the adjacent vertical members 504a and 504b. Member 502f receives the upper end of the heat transfer panel 100 therein. Referring to FIG. 11c, this shows member 502b. Member 502b is a generally elongate shape that is U-shaped in cross-section, e.g. a U-shaped beam. The member 502b is open in the direction towards the member 502f, i.e. upwardly, and the members 502b and 502f are aligned with one another. The member 502b is connected at its respective ends to the adjacent vertical members 504a and 504b. Member 502b receives the lower end of the heat transfer panel 100 therein. The members 502b and 502f are spaced the same distance away from the internal side of the transparent element 24a to define the insulation space 520b. In examples, one or both of the members 502b and 502f may include apertures (not shown) therein that may be placed into communication with the insulation space 520.

The provision of such insulation spaces 520 is advantageous as it inhibits thermal transfer between the heat transfer panels 100 and transparent elements 24a thus ensuring that the thermal energy stored in the thermal transfer medium is efficiently used by the system 30.

Referring to FIG. 1, the heat transfer panels 100 have been installed as described above so that they are placed alongside each of the transparent elements 24a of the façades 22a, 22b, 22c. Advantageously, the heat transfer panels 100 may be installed to an existing building as a retrofit installation and connected to a conventional heat management system 30 that is already part of an existing building. The heat transfer panels 100 may include valves connected to their respective inlet and outlet to permit isolation of one or more of the panels from the other panels. The heat transfer panels 100 may be fluidly connected to a single main inlet. The fluid heat transfer medium can be introduced to the heat transfer panels 100 via the main inlet to fill the heat transfer panels 100 with the fluid heat transfer medium. The fluid heat transfer medium within the heat transfer panels 100, during the summer months, for example, will absorb energy from the incident light and this energy can be transferred or recovered by the heat management system 30 for use in other applications. During the winter months, the fluid heat transfer medium may be heated by the heat management system 30 and the heat transfer panels 100 may transmit the heat from the heated fluid heat transfer medium to the interior space through thermal exchange to efficiently raise the temperature of the interior space.

In a method according to another aspect embodying the present disclosure, heat transfer panels of the type described in this disclosure may be installed to an external side of a façade of a building rather than an internal side of the façade. In this method, the heat transfer panels are placed a pre-determined distance to the external side of the transparent elements to form insulation spaces between the heat transfer panels and the transparent elements. This may be an advantageous way of installing the heat transfer panels, in, for example, hot climates for which having the insulation space to the external side of the façade is more thermally advantageous.

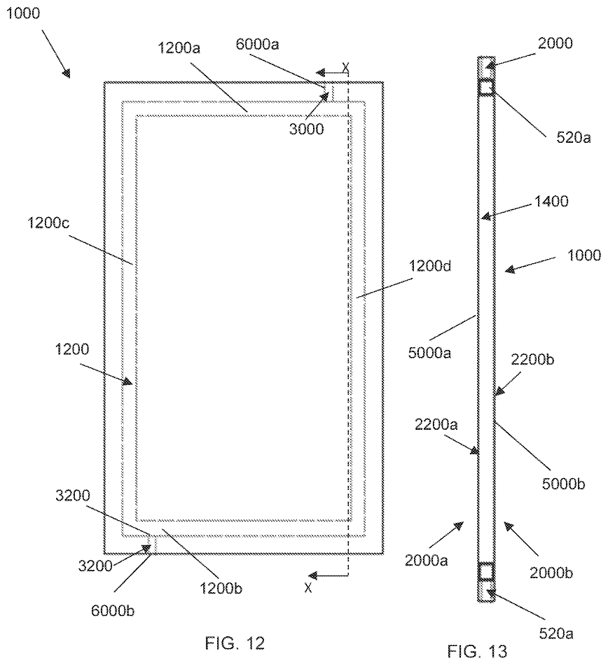

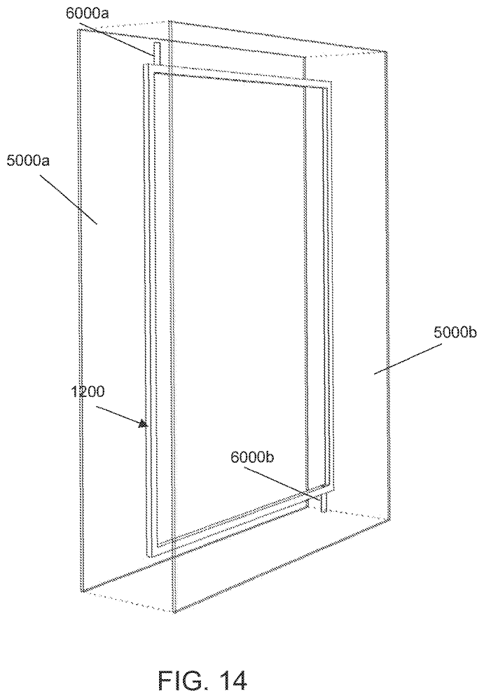

Referring to FIGS. 12 to 18, these show a heat transfer panel 1000 according to an aspect of the present disclosure. The heat transfer panel 1000 may be used with any of the previously described examples, or other systems.

The heat transfer panel 1000 includes a frame 1200. The frame 1200 is formed from separate frame members 1200a, 1200b, 1200c, 1200d connected together to form a rectangular frame. Frame members 1200a and 1200b form the upper and lower sides of the frame 1200. Members 1200a, 1200b are generally elongate. Frame members 1200c, 1200d form the lateral left and right sides of the frame 1200. Members 1200c, 12d are generally elongate. Members 1200a, 1200b are the same length, and members 1200c, 1200d are the same length and longer in length than members 1200a, 1200b. The frame members 1200a, 1200b, 1200c, 1200d may be made from metal, plastics or other suitable materials. The frame members 1200a, 1200b, 1200c, 1200d may be welded or otherwise bonded together. In examples, the frame 1200 may be made from fewer, or more frame members, and/or may be integrally formed, e.g. by casting the frame 1200 as a single component rather than separate components connected together. In examples, the frame 1200 may have other shapes, e.g. the frame 1200 may be a pentagon or hexagon-shaped, circular-shaped.

The frame 1200 defines a chamber 1400 for receiving a fluid heat transfer medium such as those described previously. The frame 1200 includes a first side 2000a, e.g. front side, and a second side 2000b, e.g. rear side, which opposes the first side 2000a. The first side 2000a and second side 2000b include respective faces forming the largest faces of the frame 1200. The first side 2000a includes a first opening 2200a, and the second side 2000b includes a second opening 2200b. The openings 2200a, 2200b are in communication with the chamber 14. The openings 2200a, 2200b are rectangular shaped and follow the shape of the frame 1200. In examples, the openings 2200a, 2200b may have other shapes where the frame 1200 is shaped differently or the openings 2200a, 2200b may have other shapes that do not follow the shape of the frame 1200, e.g. the openings may be oval whilst the shape of the frame 1200 is rectangular, or other shapes, e.g. triangular or circular shapes.

The frame 1200 includes an inlet 3000 and an outlet 3200 in communication with the chamber 1400. In the example shown in the figures, inlet 3000 is provided in the frame member 1200a and outlet 3200 is provided in the frame member 1200b. In examples, the inlet 3000 and/or outlet 3200 may be provided elsewhere, e.g. in different ones of the frame members 1200a, 1200b, 1200c, 1200d. The frame member 1200a includes apertures (not shown) in the frame 1200 to define the inlet 3000 and outlet 3200 respectively.

The heat transfer panel 1000 includes a first panel member 5000a attached to the face of the first side 2000a to cover the first opening 2200a. The first panel member 5000 is planar and has the same shape as the frame 1200 in this example. The first panel member 5000a may be made from transparent or opaque materials. For example, the first panel member 5000a may be made from plastic, glass, steel or aluminium. The heat transfer panel 1000 includes a second panel member 5000b attached to the face of the second side 2000b to cover the second opening 2200b. The second panel member 5000b is identical to the first panel member 50a in this example and will not be described in any further detail. In examples, the first and second panel members 5000a, 5000b may be different from one another and/or share fewer features in common.

The heat transfer panel 1000 includes a peripheral cavity 2000 which extends around a circumference of the heat transfer panel 1000. The peripheral cavity 2000 may extend around the whole of the circumference or only a portion thereof. In this example, the first and second panel members 5000a, 5000b extend past the frame 1200 (past the outer edge of the frame 1200) to define the peripheral cavity 2000 therebetween and outwardly of the frame 1200. In other examples, the frame 1200 may define an internal recess (e.g. through a wall which connects the first and second sides of the frame 1200) that forms the peripheral cavity. The peripheral cavity 2000 may be filled with a sealant or insulative material in examples, e.g. silicone or any other suitable material.

The heat transfer panel 1000 includes a conduit member 6000a attached to the frame member 1200a and the conduit member 6000a is in fluid communication with the chamber 1400. The conduit member 6000a is fluidly connected to the inlet of the frame 1200. The conduit member 6000a includes a first end portion 6200a proximate the frame member 1200a and defines a first aperture 6400a. The conduit member 6000a includes a second end portion 6600a distal from the frame member 1200a and defines a second aperture 6800a. Conduit member 6000a is tubular, e.g. cylindrical, but may have other shapes in examples. Conduit member 6000a may be made from the same material as the frame 1200 and may be connected to the frame member 1200a by welding or bonded thereto by other means. The conduit member 6000a includes a coupling device 7000a for releasably coupling the conduit member 6000a to other component parts as will be described. In this example, the coupling device 7000a is a co-operating formation formed on the external surface of the second end portion 6600a. The co-operating formation may be a male formation. In this example, the co-operating formation is a threaded formation.

It should be understood that, in examples, dependent on the design and requirements for a particular application, the frame 1200 may include further openings and associated conduit member/further conduit members so that there are more than the two conduit members/further conduit members shown in the figures. Similarly, there may be more than one inlet and/or outlet provided.

The heat transfer panel 1000 includes a further conduit member 6000b which is identical to conduit member 6000a. Corresponding features of the members 6000a, 6000b are denoted by the same reference numerals with the suffix ‘a’ replaced by ‘b’. Further conduit member 6000b is attached to the frame member 1200b and is fluidly connected to the outlet of the frame 1200.

The second end portions 6600a, 6600b each terminate within the peripheral cavity 2000. The second end portions 6600a, 6600b have free ends that fall within the peripheral cavity 2000 or terminate short of outer edges of the first and second panel members 5000a, 5000b. Referring to FIG. 15, this is a partial cross-section plan view of a portion of the heat transfer panel 1000 of the frame member 1200a where the conduit member 6000a is positioned. In this feature, perimeter defined by the outer edges of the panel members 5000a, 5000b is shown schematically by the line Y. It can be seen that the free end of the second end portion 6600a terminates short of the line Y.

The heat transfer panel 1000 includes an extension conduit member 7010a that may be releasably coupled to the conduit member 6000a, and a further extension conduit member 7010b (not shown in figures) that may releasably coupled to the conduit member 6000b. The heat transfer panel 1000 may include a cover member 7020a that may be coupled to the extension conduit member 7010a to cover the second aperture 6800a. The heat transfer panel 1000 may include a cover member 7020b (not shown in figures) that may be coupled to the further extension conduit member 7010b to cover the second aperture 6800b.

The extension conduit member 7010a is identical to the further extension conduit member 7010b, and the cover member 7020a is identical to the further cover member 7020b. Corresponding features of the extension conduit member 7010a and further extension conduit member 7010b (not shown) are denoted by the same reference numerals with the suffix ‘a’ replaced by ‘b’. The cover member 7020a is identical to the cover member 7020b (not shown) and corresponding features are denoted by the same reference numerals with the suffix ‘a’ replaced by ‘b’.

For the purpose of description, only the conduit member 6000a, extension conduit member 7010a, and cover member 7020a will be described in detail with the understanding that the further conduit member 6000b, extension member 7010b and cover member 7020b share the same or similar features and configuration. Although the example shown in the figure has a conduit member 6000a forming a male connection that is received in female connections of the extension conduit member 7010a and cover member 7020a, these may be arranged oppositely in other examples. This is also true of the further conduit member 6000b, further extension conduit member 7010b and further cover member 7020b.

Referring to FIG. 18, this corresponds to the view of FIG. 15 with the extension conduit member 7010a coupled to the conduit member 6600a. Extension conduit member 7010a is generally tubular, e.g. generally cylindrical shaped. The extension conduit member 7010a includes a first end portion 7012a and an opposite second end portion 7014a. In this example, first end portion 7012a has larger internal diameter than the second end portion 7014a. The internal surface of the first end portion 7012a includes a co-operating formation 7016a. In examples, the co-operating formation 7016a is a female formation. The co-operating formation 7016a may be a threaded formation. The first end portion 7012a includes an aperture and the second end portion 7014a includes an aperture. In the coupled state, the co-operating formation 7016a is connected to the co-operating formation of the coupling device 7000a. The extension conduit member 7010a, when connected to the conduit member 7010a, has a free end, e.g. the end of the second portion 7014a, that is positioned outside of the peripheral cavity 2000. The free end is positioned past the perimeter defined by the panel members 5000a, 5000a and sits proud of the rest of the heat transfer panel 1000 to permit connection thereto.

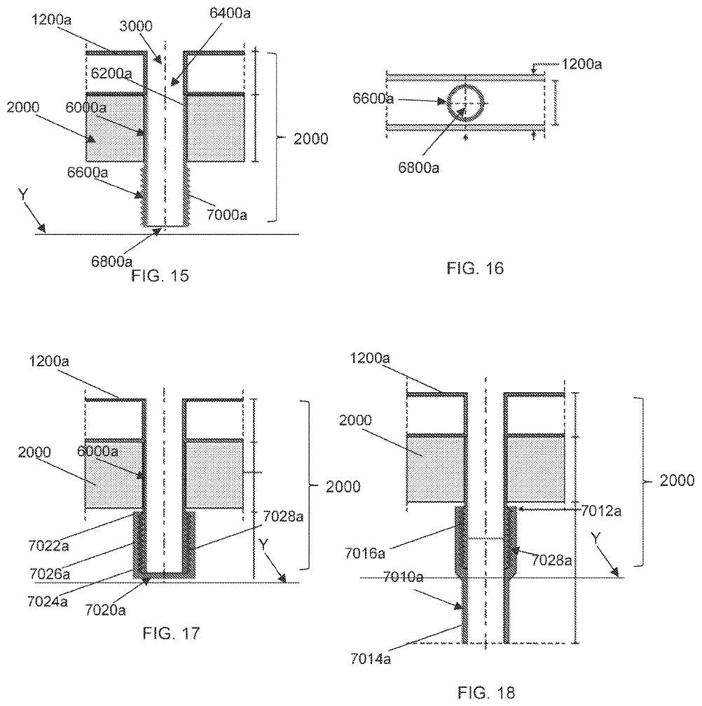

Referring to FIG. 17, this corresponds to the view of FIG. 15 with the cover member 7020a coupled to the conduit member 6000a. Cover member 7020a is generally cylindrical shaped. The cover member 7020a has a first end 7022a, which is open and defines an aperture therein, and an opposite second end 7024a which is a closed. The first and second ends 7022a, 7024a are connected by a wall 7026a extending therebetween. The internal surface of the wall 7026a includes a co-operating formation 7028a. In examples, the co-operating formation 7028a is a female formation. The co-operating formation 7028a may be a threaded formation. In the coupled state, the co-operating formation 7028a is connected to the co-operating formation of the coupling device 7000a. In other examples according to the present disclosure, the cover member 7020a may be configured differently and may, for example, be configured as a plug that is inserted into the conduit member 6000a to close it.

The coupling device 7000a, and formations 7016a, 7028a, are configured to be complementary connections so that each of the formations 7016a, 7028a can be connected to the coupling device 7000a.

The heat transfer panel 1000 described may be manufactured to include the conduit member 6600a. By having the conduit member 6600a terminate within the peripheral cavity 2000, the conduit member 6600a does not protrude past the perimeter of the heat transfer panel 1000. Once the conduit member 6600a has been connected to the frame member 1200a, e.g. by welding, or formed, the peripheral cavity 2000 may be filled with sealant material other than a small region surrounding the part of the second end portion 6600a which includes the coupling device 7000a to permit access thereto.

Advantageously, having a conduit member 6600a as described, permits easier handling of the heat transfer panel 1000 during manufacture, delivery and installation of the heat transfer panel 1000 compared to a heat transfer panel of the type shown in FIG. 3 because there is no conduit member 6600a which extends proud of the rest of the heat transfer panel 1000. In order to install the heat transfer panel 1000, a user may simply connect the extension conduit member 6600b through the coupling device 7000a so that the second end portion 7800b of the extension conduit member 6600b sits proud of the rest of the heat transfer panel 1000 to permit a conduit for transferring fluid heat transfer medium to be connected thereto.

Advantageously, in examples where a cover member 7020a is provided, this may be connected to the conduit member 6600a as part of the manufacture process to prevent any debris, dirt or other material from entering the heat transfer panel 1000 prior to its installation. The cover member 7020a may be removed during installation to permit the extension conduit member 6600b to be connected thereto.

In examples, by ensuring that no portions protrude past the perimeter of the panels, standard sealing techniques and manufacturing equipment used in glass production may be used to manufacture the panels thus further lowering manufacturing costs and improving quality.

In examples in accordance with the present disclosure, any of the above described heat transfer panels may be provided with further panels, e.g. so that the heat transfer panel has two internal chambers with one of the chambers containing the thermal transfer medium and the other chamber containing air, other gas or is a sealed vacuum to provide an insulative effect. When used in this specification and claims, the terms “comprises” and “comprising” and variations thereof mean that the specified features, steps or integers are included. The terms are not to be interpreted to exclude the presence of other features, steps or components.

It will be appreciated that the present disclosure may also relate to buildings having transparent elements or windows which may be openable windows and to which heat transfer panels may be installed as will be appreciated by the skilled person.

In the examples described, the transparent element may form part of a window wherein the window has its own support structure, e.g. frame, in which the transparent element is supported. In such examples, the heat transfer panel fixed relative to the transparent element is positioned adjacent to the window and may be substantially aligned relative to the window.

The invention may also broadly consist in the parts, elements, steps, examples and/or features referred to or indicated in the specification individually or collectively in any and all combinations of two or more said parts, elements, steps, examples and/or features. In particular, one or more features in any of the embodiments described herein may be combined with one or more features from any other embodiment(s) described herein.

Protection may be sought for any features disclosed in any one or more published documents referenced herein in combination with the present disclosure.

Although certain example embodiments of the invention have been described, the scope of the appended claims is not intended to be limited solely to these embodiments. The claims are to be construed literally, purposively, and/or to encompass equivalents.

1. A method of installing a heat transfer panel to a building, the building including:
a load bearing structure for bearing the load of the building and transferring the load to a foundation of the building; and
a façade including a transparent element for permitting light to pass therethrough, wherein the transparent element has an internal side and an external side, and
the method including:
a) providing a heat transfer panel including a frame, and opposing first panel member and second panel members defining a chamber for receiving a fluid heat transfer medium;
b) placing the heat transfer panel to the internal side of the transparent element so that least a portion of the heat transfer panel coincides with at least a portion of the transparent element to permit light passing through the transparent element to transfer energy to the heat fluid transfer medium during use; and
c) after placing the heat transfer panel in step b), fixing the heat transfer panel relative to the façade.

2. A method according to claim 1 wherein the internal side has an inwardly facing surface which directly defines a user accessible space of the building during normal use, and/or
wherein the transparent element is an innermost positioned section of the façade in the building relative to the rest of the façade.

3. A method of installing a heat transfer panel to a building, the building including:
a load bearing structure for bearing the load of the building and transferring the load to a foundation of the building; and
a façade including a transparent element for permitting light to pass therethrough, wherein the transparent element has an internal side and an external side, and
the method including:
a) providing a heat transfer panel including a frame, and opposing first panel member and second panel members defining a chamber for receiving a fluid heat transfer medium;
b) placing the heat transfer panel a pre-determined distance to the external side of the transparent element to form an insulation space between the heat transfer panel and the transparent element and so that least a portion of the heat transfer panel coincides with at least a portion of the transparent element to permit light passing through the transparent element to transfer energy to the heat fluid transfer medium during use; and
c) after placing the heat transfer panel in step b), fixing the heat transfer panel relative to the façade.

4. A method according to claim 1 wherein the heat transfer panel is configured to permit light to pass therethrough so that light can enter the building by passing through the heat transfer panel and the transparent element whilst permitting a user to see out of the building by looking through the heat transfer panel and the transparent element.

5. A method according to claim 1 wherein the heat transfer panel is configured so that the heat transfer medium is directly heated by light passing through the first and/or second panel members.

6. A method according to claim 1 wherein at least a portion of the first and/or second panel members coincide with at least a portion of the transparent element, all, or a major portion, of the first and/or second panel members coincide with all, or a major portion of the transparent element.

7. A method according to claim 1, wherein, the first and/or second panel members permit light to pass therethrough, the first and/or second panel members are transparent or optically clear, and step b) includes the heat transfer panel being placed relative to the transparent element to permit light passing through the transparent element to pass through the first and/or second panel members to the heat transfer medium during use.

8. A method according to claim 1 wherein step b) includes placing the heat transfer panel a pre-determined distance from the internal side of the transparent element to form an insulation space between the heat transfer panel and the transparent element.

9. A method according to claim 8 including a step of sealing the insulation space.

10. A method according to claim 8 including a step of removing fluid from the insulation space, portion or all of the gaseous fluid.

11. A method according to claim 8 including providing a valve and fluidly connecting the valve to the insulation space, wherein the valve is operable between an open state, in which fluid communication with the insulation space is permitted by the valve, and a closed state, in which fluid communication with the insulation space is inhibited by the valve, and the valve is a one-way valve that only permits fluid to flow out of the insulation space.

12. A method according to claim 1, wherein, the building first and second sections connected to the load bearing structure define an interior space of a level of the building, and the façade extends at least a portion between the first and second sections, and wherein step c) includes fixing respective part(s) of the heat transfer panel to the first and second sections respectively.

13. A method according to claim 1, wherein, the façade includes a support structure for supporting and fixing thereto the transparent element, and wherein step b) includes providing an internal support structure for supporting the heat transfer panel and fixing the heat transfer panel to the internal support structure.

14. A method according to claim 13 wherein the internal support structure is fixed to the support structure and the internal support structure is fixed to the load bearing structure to inhibit the support structure from bearing the load created by the heat transfer panel.

15. A method according to claim 13, wherein the support structure includes:
one or more horizontal members; and
one or more vertical members,
wherein the respective one or more horizontal and vertical members are connected to support and have fixed thereto respective parts of the transparent element, and wherein the internal support structure includes:
one or more horizontal members; and
one or more vertical members,
wherein the respective one or more horizontal and vertical members are connected to support and have fixed thereto respective parts of the heat transfer panel.

16. A method according to claim 15, wherein step b) includes:
ones of the one or more vertical members of the internal support structure being placed adjacent to respective ones of the one or more vertical members of the internal support structure, and being aligned relative thereto; and/or
ones of the one or more horizontal members of the internal support structure being placed adjacent to respective ones of the one or more horizontal members of the internal support structure, being aligned relative thereto.

17. A method according to claim 3, wherein, the façade includes a support structure for supporting and fixing thereto the transparent element, and wherein step b) includes providing an internal support structure for supporting the heat transfer panel and fixing the heat transfer panel to the internal support structure, wherein the method includes positioning the internal support structure relative to the transparent element to support the heat transfer panel so that the heat transfer panel is at the pre-determined distance to form the insulation space, the internal support structure seals the insulation space.

18. A method according to claim 17, wherein the heat transfer panel includes an inlet in communication with the chamber, and the method includes providing a conduit for the passage of a fluid heat transfer medium, and fluidly connecting the conduit to the inlet to permit a fluid heat transfer medium to flow between the chamber and the conduit during use.

19. A method according to claim 18 wherein, the façade includes a support structure for supporting and fixing thereto the transparent element, and wherein step b) includes providing an internal support structure for supporting the heat transfer panel and fixing the heat transfer panel to the internal support structure, wherein the internal support structure defines an internal space for receiving the conduit, and the method includes placing the conduit in the internal space prior to fluidly connecting the conduit to the inlet.

20. A method according to claim 19, dependent on claim 17, wherein a one of the one or more horizontal members define the internal space, and the method includes placing the conduit into the one of the one or more horizontal members.

21. A method according to claim 1, wherein the façade includes multiple transparent elements each having a respective internal and external side, and:
step a) includes providing multiple said heat transfer panels that correspond to the multiple transparent elements;
step b) includes placing each heat transfer panel to the internal side of the corresponding transparent element so that least a portion of the heat transfer panel coincides with a portion of the transparent element to permit light passing through the transparent element to transfer energy to the heat fluid transfer medium during use; and
step c) includes after placing each heat transfer panel in step b), fixing each heat transfer panel relative to the external wall or façade.

22. A method according to claim 21 wherein the method includes: fluidly connecting a portion, or all, of the said heat transfer panels together to permit fluid heat transfer medium to flow between the heat transfer panels during use; and/or the building includes multiple said façades, and the method is performed to install heat transfer panels to more than one of the said façades; and/or the method includes providing a fluid control system for selectively permitting fluid heat transfer medium to flow between the said heat transfer panels, and/or selectively forming one or more fluid heat transfer medium circuits between the said heat transfer panels to prevent the flow of fluid heat transfer medium between the one or more fluid heat transfer medium circuits.

23. A method according to claim 21 wherein the multiple said façades include:
a first façade which faces in a first direction; and
a second façade which faces in a second direction that is different to the first direction; an opposite direction to the first direction; and
the method includes:
selecting the first and second façades, installing the heat transfer panels to the first and second façades to form first and second fluid heat transfer medium circuits, and
fluidly connecting the first and second fluid heat transfer medium circuits.

24. A method according to claim 1 including one or more or all of:
a) wherein the building includes a heat management system and the method includes thermally connecting the heat transfer panel(s) to the heat management system to permit the transfer of heat between the fluid heat transfer medium and the heat management system, optionally or preferably the heat management system includes one or more of a heat exchanger, heat storage device and heat pump, and the method includes thermally connecting the heat transfer panel to one or more of the heat exchanger, heat storage device, heat pump, a heating device, cooling device or energy source; and
b) wherein the façade(s) are pre-existing façade(s) of the building.

25. A building including:
a façade including a transparent element for permitting light to pass therethrough, wherein the transparent element has an internal side and an external side, and
a heat transfer panel including a frame, and opposing first panel member and second panel members defining a chamber for receiving a fluid heat transfer medium,
wherein the heat transfer panel is positioned a pre-determined distance to the external side of the transparent element to form an insulation space so that least a portion of the heat transfer panel coincides with at least a portion of the transparent element to permit light passing through the transparent element to transfer energy to the heat fluid transfer medium during use.

26. A building according to claim 25 including one or more or all of:
a) wherein the façade includes multiple transparent elements each having a respective internal and external side, and multiple said heat transfer panels that correspond to the multiple transparent elements, wherein each heat transfer panel is positioned a pre-determined distance to the external side of the corresponding transparent element to form an insulation space and so that least a portion of the heat transfer panel coincides with a portion of the transparent element to permit light passing through the transparent element to transfer energy to the heat fluid transfer medium during use;
b) wherein a portion, or all, of the said heat transfer panels are fluidly connected together to permit fluid heat transfer medium to flow between the heat transfer panels during use; and
c) the building includes multiple said façades, and includes multiple said heat transfer panels, wherein each heat transfer panel is positioned to the internal side of the corresponding transparent element so that least a portion of the heat transfer panel coincides with at least a portion of the transparent element to permit light passing through the transparent element to transfer energy to the heat fluid transfer medium during use; and/or the building includes a fluid control system for selectively permitting fluid heat transfer medium to flow between the said heat transfer panels, and/or selectively forming one or more fluid heat transfer medium circuits between the said heat transfer panels to prevent the flow of fluid heat transfer medium between the one or more fluid heat transfer medium circuits.

27. A heat transfer panel for use in a building including:
a frame including at least one frame member including:
a chamber for receiving a fluid heat transfer medium;
a first side including a first opening in communication with the chamber and a face;
a second side, opposite the first side, including a second opening in communication with the chamber and a face;
an inlet in communication with the chamber;
an outlet in communication with the chamber;
a first panel member attached to the face of the first side to cover the first opening and a second panel member attached to the face of the second side to cover the second opening,
wherein the heat transfer panel includes a peripheral cavity which extends around a circumference of the heat transfer panel;
a conduit member connected to the frame and in fluid communication with the chamber, wherein the conduit member includes:
a first end portion proximate the at least one frame member and defines a first aperture;
a second end portion distal from the at least one frame member and defines a second aperture; and
a coupling device for releasably coupling the conduit member to an extension conduit member,
wherein the second end portion terminates within the peripheral cavity.

28. A heat transfer panel according to claim 27 including one or more or all of the following:
a) the coupling device is for releasably coupling a cover member for covering the second aperture, the cover member is coupled to the coupling device;
b) the coupling device includes a first co-operating formation formed on the second end portion for co-operating with a respective co-operating formation of the extension conduit member and/or a respective co-operating formation of the cover member;
c) the first end portion of the conduit member is connected to a part of the frame that defines the inlet;
d) the one or both of the first and second panel members extend past the frame, extend past the frame to define the peripheral cavity;
e) a further conduit member connected to the at least one frame member and in fluid communication with the chamber, wherein the further conduit member includes:
a first end portion proximate the frame and defines a first aperture;
a second end portion distal from the frame and defines a second aperture; and
a coupling device for releasably coupling the conduit member to one of: an extension conduit member, and/or a cover member for covering the second aperture,
wherein the second end portion terminates within the peripheral cavity; f) the inlet is an aperture in the frame and/or the outlet is an aperture in the at least one frame member;
g) the first aperture of the conduit is aligned to the inlet and/or the first aperture of the further conduit is aligned to the outlet;
h) the peripheral cavity extends around the entire circumference of the frame; and
i) the peripheral cavity contains a sealant material.
